(19) United States
(12) Patent Application Publication
(10) Pub. No.: US 2026/0231242 A1
(43) Pub. Date: Aug. 6, 2026

(54) METHOD AND APPARATUS FOR UPDATING TA IN INACTIVE MODE IN WIRELESS COMMUNICATION SYSTEM

(71) Applicant: Samsung Electronics Co., Ltd., Suwon-si, Gyeonggi-do (KR)

(72) Inventors: Taeseop LEE, Suwon-si (KR); Anil AGIWAL, Suwon-si (KR)

(21) Appl. No.: 19/133,979

(22) PCT Filed: Feb. 2, 2024
(86) PCT No.: PCT/KR2024/001615

§ 371 Date: May 29, 2025

(30) Foreign Application Priority Data
Feb. 9, 2023 (KR) 10-2023-0017417

(51) Int. Cl. H04W 74/0838; H04B 17/318; H04W 72/23; H04W 76/27

(52) U.S. Cl. CPC H04W 74/0838; H04B 17/328; H04W 72/23; H04W 76/27

(57) ABSTRACT

The present disclosure relates to a 5G or 6G communication system for supporting higher data transmission rates. Specifically, the present disclosure proposes a method and an apparatus for performing a RACH procedure to update a TA of a terminal in an RRC inactive state.

### TECHNICAL FIELD

The disclosure relates to a wireless communication system (or a mobile communication system). Specifically, the disclosure relates to operations of a terminal and a base station in a wireless communication system (or a mobile communication system) and, particularly, to a method and a device for providing a position estimation service of a terminal in an inactive state in a next-generation mobile communication system.

### BACKGROUND ART

5G mobile communication technologies define broad frequency bands to enable high transmission rates and new services, and can be implemented not only in “Sub 6 GHZ” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving g system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, with the recent advancement in communication systems, the demand for improving the efficiency of position estimation for terminals in an inactive state has been steadily increasing.

### DISCLOSURE OF INVENTION

### Technical Problem

The disclosure provides an efficient method for updating a timing advance (TA) value used for uplink transmission by a terminal in a radio resource control (RRC) inactive (or INACTIVE) state. More specifically, an efficient random access method and device for updating a TA value used for transmission of a sounding reference signal by a terminal in an RRC inactive state during position estimation of the terminal in a mobile communication system are proposed.

### Solution to Problem

A method performed by a terminal according to an embodiment of the disclosure includes: receiving a radio resource control (RRC) release message for configuring an RRC inactive state from a base station; identifying that a timer associated with a positioning sounding reference signal (SRS) has expired in the inactive state; and transmitting a contention-free random access preamble for timing advance (TA) update to the base station.

A method performed by a base station according to an embodiment of the disclosure includes: transmitting a radio resource control (RRC) release message for configuring an RRC inactive state to a terminal; and upon expiration of a timer associated with a positioning sounding reference signal (SRS) related to the inactive state, receiving a contention-free random access preamble for timing advance (TA) update from the terminal.

A terminal according to an embodiment of the disclosure includes: a transceiver; and a controller connected to the transceiver, wherein the controller is configured to: receive a radio resource control (RRC) release message for configuring an RRC inactive state from a base station; identify that a timer associated with a positioning sounding reference signal (SRS) has expired in the inactive state; and transmit a contention-free random access preamble for timing advance (TA) update to the base station.

A base station according to an embodiment of the disclosure includes: a transceiver; and a controller connected to the transceiver, wherein the controller is configured to: transmit a radio resource control (RRC) release message for configuring an RRC inactive state to a terminal; and upon expiration of a timer associated with a positioning sounding reference signal (SRS) related to the inactive state, receive a contention-free random access preamble for timing advance (TA) update from the terminal.

### Advantageous Effects of Invention

According to various embodiments proposed in the disclosure, the power consumption of a terminal in an inactive state for position estimation of the terminal can be reduced.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

The above and other aspects, features, and advantages will be more apparent from the following description of embodiments of the disclosure with reference to the accompanying drawings.

FIG. 1 illustrates a structure of a next-generation mobile communication system according to an embodiment of the disclosure.

FIG. 2 illustrates a network structure according to an embodiment of the disclosure.

FIG. 3 is a diagram illustrating a process of configuring a sounding reference signal (SRS) resource of a terminal, according to an embodiment of the disclosure.

FIG. 4 is a diagram illustrating a process in which a terminal in an RRC_INACTIVE state receives SRS transmission configuration information and transmits an SRS, according to an embodiment of the disclosure.

FIG. 5 is a diagram illustrating a procedure in which, when a timing advance timer (TAT) expires during SRS transmission by a terminal in an RRC_INACTIVE state, the terminal transitions to an RRC_CONNECTED state and receives a new SRS transmission configuration, according to an embodiment of the disclosure.

FIG. 6 is a diagram illustrating a procedure in which a terminal updates a TA value through contention-based random access (CBRA) in an RRC_INACTIVE state, according to an embodiment of the disclosure.

FIG. 7 is a diagram illustrating a procedure in which a terminal updates a TA value through contention-free random access (CFRA) in an RRC_INACTIVE state, according to an embodiment of the disclosure.

FIG. 8 is a diagram illustrating a method for performing CBRA and updating a TA value by a terminal in an RRC_INACTIVE state, by using a random access resource configured for timing advance (TA) update, according to an embodiment of the disclosure.

FIG. 9 is a flowchart illustrating operations when a terminal receives SRS transmission configuration information in an RRC_INACTIVE state, according to an embodiment of the disclosure.

FIG. 10 is a block diagram illustrating an internal structure of a UE according to an embodiment of the disclosure.

FIG. 11 is a block diagram illustrating a structure of a base station according to an embodiment of the disclosure.

### MODE FOR THE INVENTION

Hereinafter, the operation principle of the disclosure will be described in detail in conjunction with the accompanying drawings. In addition, a detailed description of known functions or configurations that may make the subject matter of the disclosure unclear will be omitted. The terms which will be described below are terms defined in consideration of the functions in the disclosure, and may be different according to users, intentions of the users, or customs. Therefore, the definitions of the terms should be made based on the contents throughout the specification. Hereinafter, embodiments of the disclosure will be described with reference to the accompanying drawings.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) standards may be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the examples given above are not limiting.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or UE) transmits data or control signals to a base station (or eNB or gNB), and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with low latency (ultra-low latency) and high reliability (ultra-high reliability). For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. Furthermore, based on determinations by those skilled in the art, the embodiments of the disclosure may also be applied to other communication systems through some modifications without significantly departing from the scope of the disclosure.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

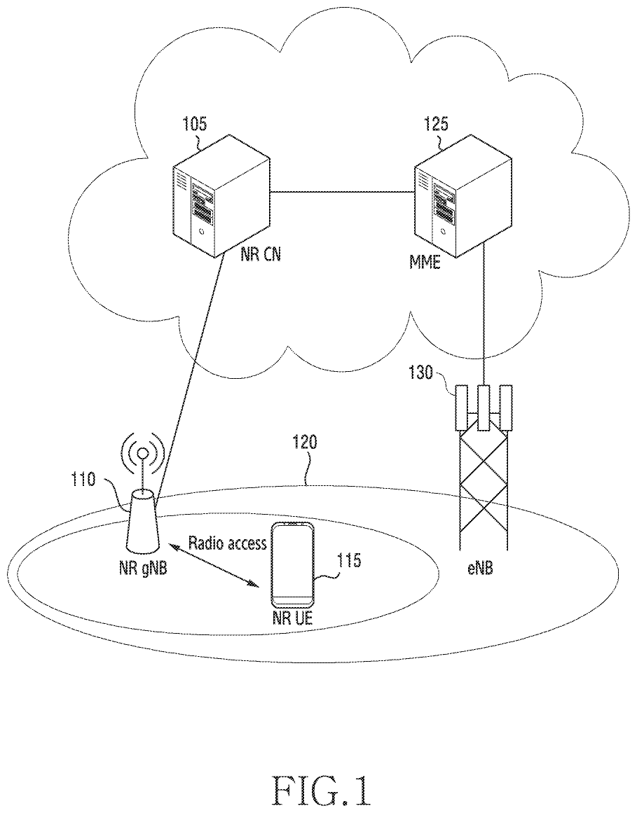

FIG. 1 illustrates a structure of a next-generation mobile communication system according to an embodiment of the disclosure.

Referring to FIG. 1, a radio access network of a next-generation mobile communication system (hereinafter NR or 5G) may include a next-generation base station (new radio node B, hereinafter NR NB, gNB, NR gNB, or NR base station) 110, and a new radio core network (NR CN) 105. Of course, the above example is not limiting, and the radio access network of the next-generation mobile communication system may include a larger number of network entities (or network nodes) than those of the above example. A user terminal (new radio user equipment, hereinafter NR UE or NR terminal) 115 may access an external network via the NR gNB 110 and the NR CN 105.

The NR gNB 110 is connected to the NR UE 115 through a radio channel 120 and may provide outstanding services as compared to a conventional node B. In the next-generation mobile communication system, since all user traffic is serviced through a shared channel, a device that collects state information, such as buffer statuses, available transmit power states, and channel states of UEs, and performs scheduling accordingly is required, and the NR gNB 110 serves as the device. In general, one NR gNB 110 may control multiple cells.

According to an embodiment of the disclosure, in order to implement ultrahigh-speed data transfer beyond the current LTE, the next-generation mobile communication system may provide a wider bandwidth than the existing maximum bandwidth, may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 105 may perform functions such as mobility support, bearer configuration, and QoS configuration. The NR CN 105 is a device responsible for various control functions as well as a mobility management function for a UE, and may be connected to multiple base stations. In addition, the next-generation mobile communication system may interwork with the existing LTE system, and the NR CN 105 may be connected to an MME 125 via a network interface. The MME may be connected to an eNB 130 that is an existing base station.

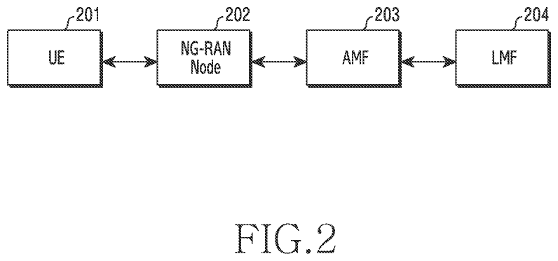

FIG. 2 illustrates a network structure according to an embodiment of the disclosure.

Specifically, FIG. 2 illustrates a network structure for providing UE positioning services in a next-generation mobile communication system according to an embodiment of the disclosure. The term “UE positioning services” may hereinafter be used interchangeably with the term “LoCation Services (LCS)”.

Referring to FIG. 2, a network for providing LCS in a next-generation mobile communication system may include a UE 200, a base station (NG-RAN node) 202, an access and mobility function (AMF) 203, and a location management function (LMF) 204, and may further include a larger number of network entities, network nodes, or network functions than the components illustrated in FIG. 2. The UE 201 may communicate with the LMF 204 through the NG-RAN node 202 and the AMF 203, and may exchange information necessary to position the UE. The role of each component for providing LCS is as follows.

The UE 201 may measure a radio signal necessary to position the UE and may transfer the measurement result to the LMF 204.

The NG-RAN node 202 may transmit a downlink radio signal necessary to position the UE and may measure an uplink radio signal transmitted by a target UE.

The AMF 203 may receive an LCS request message from an LCS requester and may then transfer the LCS request message to the LMF 204, thereby requesting (or indicating) to provide UE location services. If the LMF 204 processes the LCS (or positioning) request and then transmits (or responds) a response message regarding a result of positioning the UE to the AMF 203, the AMF 203 may, upon receiving the response message (or response), transfer the result of positioning the UE to the LCS requester.

The LMF 204 may receive the LCS request message from the AMF 203 (have the LCS request message transferred therefrom) and process the same, and may control the overall process necessary for positioning the UE. In order to position the UE, the LMF 204 may provide the UE 201 with auxiliary information necessary for positioning and signal measurement and may acquire (or receive) the result value, and an LTE positioning protocol (LPP) may then be used as a protocol for data exchange. The LPP may define a message specification used between the UE 201 and the LMF 204 for LCS. In addition, the LMF 204 may exchange positioning reference signal (hereinafter, referred to as PRS) configuration information and sounding reference signal (hereinafter, referred to as SRS) measurement results, which are to be used for positioning, with the NG-RAN node 202 as well. With regard to this, NR positioning protocol A (NRPPa) may be used as a protocol for data exchange, and NRPPa may define a message specification used between the NG-RAN node 202 the LMF 204.

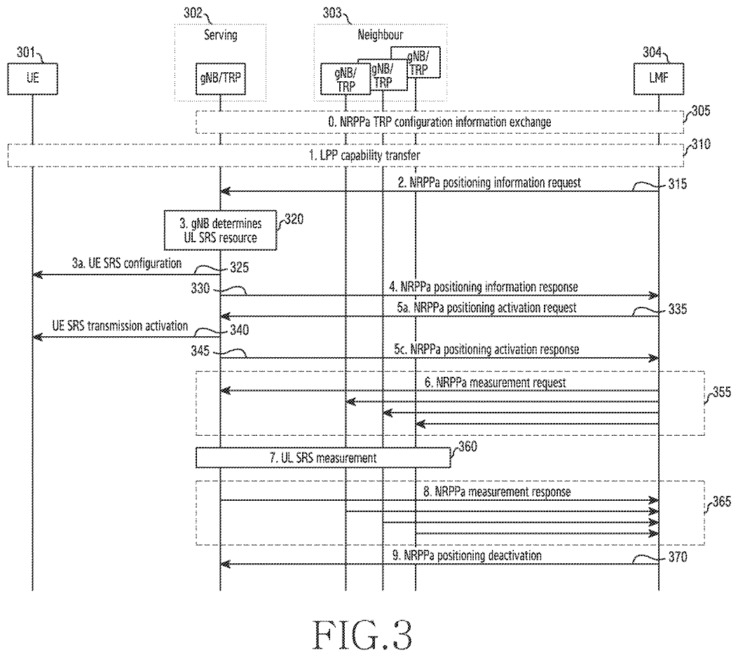

FIG. 3 is a diagram illustrating a process of configuring a sounding reference signal (SRS) resource of a UE, according to an embodiment of the disclosure.

More specifically, FIG. 3 is a diagram illustrating a process in which an LMF 304 configures sounding reference signal (SRS) transmission required for a UE 301 to perform at least one operation of a UL positioning method or a DL+UL positioning method.

The UL positioning method may refer to a manner of estimating the position of a UE, based on an uplink signal transmitted by the UE. For example, the method may include a manner in which a UE transmits an SRS signal through an uplink, and a gNB or TRP which has received (or measured) the SRS signal transmitted by the UE estimates the position of the UE, based on obtained SRS measurement information (or measured result value).

The DL+UL positioning method may refer to a manner of estimating the position of a UE, based on a downlink signal transmitted by a gNB/TRP and an uplink signal transmitted by the UE. For example, the gNB/TRP may transmit a positioning reference signal (PRS) through a downlink. The UE having received the PRS transmitted by the gNB/TRP may obtain PRS measurement information (or measured result value). The UE transmits an SRS signal through an uplink, and the gNB/TRP having received (or measured) the SRS signal transmitted by the UE may obtain SRS measurement information (or measured result value). Thereafter, the gNB/TRP may estimate the position of the UE by using both the PRS measurement information (or measured result value) measured by the UE and the SRS measurement information (or measured result value) measured by the gNB/TRP.

Therefore, in order to estimate the position of a UE by using at least one of the UL positioning method or the UL+DL positioning method, a procedure for configuring the UE to transmit an SRS needs to be performed. Hereinafter, a procedure performed in each operation will be described.

In step 305, the LMF 304 may exchange NRPPa TRP configuration information with a Serving gNB/TRP 302 and a Neighbour gNB/TRP 303. (0. NRPPa TRP Configuration Information Exchange in FIG. 3)

The LMF 304 may obtain information required to perform the UL positioning method from the Serving gNB/TRP 302 and the Neighbour gNB/TRP 303. The information required to perform the UL positioning method may include at least one of NR cell information, PRS configuration, spatial direction information, or position information. In step 310, UE capability information may be exchanged between the LMF 304 and the UE 301. (1. LPP Capability Transfer in FIG. 3)

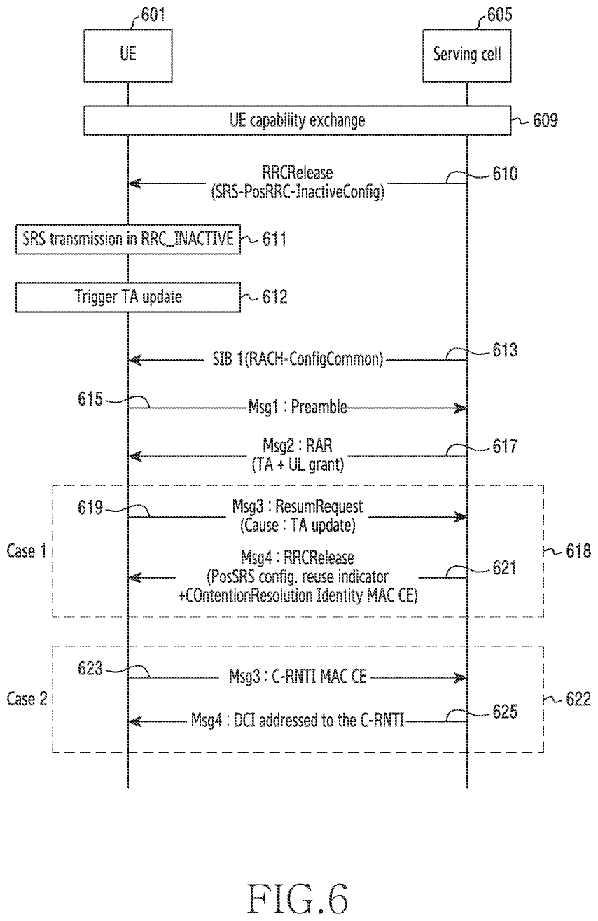

The LMF 304 may request UE capability information related to position estimation from the UE 302 and receive a response, and the detailed content is described in FIG. 6 below.

In step 315, the LMF 304 may transmit an NRPPa positioning information request message to the Serving gNB/TRP 302. (2. NRPPa POSITIONING INFORMATION REQUEST in FIG. 3)

The NRPPa positioning information request message transmitted by the LMF 304 may include information for determining an SRS transmission resource configuration of the UE required for UL positioning, based on information pre-collected by the LMF (e.g., position information of adjacent TRPs, existing position information of the UE, SSB/PRS transmission information of the TRPs, etc.) and requesting the determined configuration from the Serving gNB/TRP 302. The message may include at least one piece of information among the number of required SRS resources, periodicity, pathloss reference, or spatial relation.

In step 320, the Serving gNB/TRP 302 may finally determine an SRS resource for the UE to transmit an SRS. (3. gNB Determines UL SRS Resources in FIG. 3)

After receiving the NRPPa positioning information request message from the LMF 304, the Serving gNB/TRP 302 may finally determine an SRS resource to be configured for the UE, based on the received message.

In step 325, the Serving gNB/TRP 302 may transfer SRS resource configuration information (or SRS resource transmission configuration information, UE SRS configuration) determined in step 320 to the UE 301. (3a. UE SRS configuration in FIG. 3)

The Serving gNB/TRP 302 may transfer the SRS resource configuration information to the UE 301 through RRC signaling.

In step 330, the Serving gNB/TRP 302 may transmit an NRPPa positioning information response message to the LMF 304. (4. NRPPa POSITIONING INFORMATION RESPONSE in FIG. 3)

The NRPPa positioning information response message transmitted by the Serving gNB/TRP 302 may be used to transfer, to the LMF, the SRS resource configuration information (e.g., the position of an SRS resource on the time/frequency axis, periodicity, spatial relation information, etc.) finally transferred to the UE 301 by the Serving gNB/TRP 302 in step 325.

In step 335, the LMF 304 may transmit an NRPPa POSITIONING ACTIVATION request message to the Serving gNB/TRP 302. (5a. NRPPa POSITIONING ACTIVATION REQUEST in FIG. 3)

The NRPPa POSITIONING ACTIVATION request message may be used by the LMF 304 to request the Serving gNB/TRP 302 to activate SRS transmission of the UE 301 when the UE 302 is configured to transmit a semi-persistent or an aperiodic SRS.

In step 340, the Serving gNB/TRP 302 may configure the UE 301 to activate SRS transmission. (5b. Activate UE SRS transmission in FIG. 3)

The Serving gNB/TRP 302 having received the NRPPa POSITIONING ACTIVATION REQUEST message may perform a process of indicating the UE 340 to perform SRS activation through a medium access control (MAC) control element (CE) or downlink control information (DCI).

In step 345, the Serving gNB/TRP 302 may transmit an NRPPa POSITIONING ACTIVATION RESPONSE message to the UE 301. (5c. NRPPa POSITIONING ACTIVATION RESPONSE in FIG. 3)

The NRPPa POSITIONING ACTIVATION RESPONSE message may be used by the Serving gNB/TRP 302 to transfer information on whether SRS activation has been completed (or whether SRS activation has been completed) to the LMF 304, in response to the NRPPa POSITIONING ACTIVATION REQUEST message.

In step 355, the LMF 304 may transmit an NRPPa MEASUREMENT REQUEST message. (6. NRPPa MEASUREMENT REQUEST in FIG. 3)

The NRPPa MEASUREMENT REQUEST message may be used by the LMF 304 to request the Serving gNB/TRP 302 and the Neighbour gNB/TRP 303 to measure an SRS transmitted by the UE and report a result of the measurement. In this case, the NRPPa MEASUREMENT REQUEST message may include SRS resource information configured for the UE 301.

In step 360, the Serving gNB/TRP 302 and the Neighbour gNB/TRP 303 may measure an SRS transmitted by the UE 301. (7. UL SRS Measurements in FIG. 3)

The Serving gNB/TRP 302 and the Neighbour gNB/TRP 303 having received an SRS measurement request from the LMF 304 through the NRPPa MEASUREMENT REQUEST message may measure an SRS transmitted by the UE 301, based on SRS configuration information included in the NRPPa MEASUREMENT REQUEST message.

In step 365, the Serving gNB/TRP 302 and the Neighbour gNB/TRP 303 may transmit an NRPPa MEASUREMENT RESPONSE message to the LMF 304. (8. NRPPa MEASUREMENT RESPONSE in FIG. 3)

The NRPPa MEASUREMENT RESPONSE message may be used by the Serving gNB/TRP 302 and the Neighbour gNB/TRP 303, which have received the SRS measurement request from the LMF 304 in step 355 described above, to transfer an SRS measurement result to the LMF 304.

In step 370, the LMF 304 may transmit an NRPPa POSITIONING DEACTIVATION message to the Serving gNB/TRP 302. (9. NRPPa POSITIONING DEACTIVATION in FIG. 3)

The NRPPa POSITIONING DEACTIVATION message may be used by the LMF 304 to transmit to the Serving gNB/TRP 302 in order to deactivate the SRS transmission requested in step 335 after completing a position estimation technique operation.

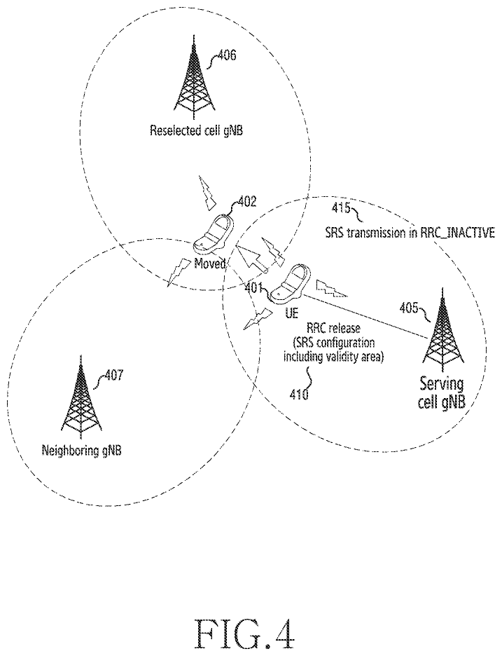

FIG. 4 is a diagram illustrating a process in which a UE in an RRC_INACTIVE state receives SRS transmission configuration information and transmits an SRS, according to an embodiment of the disclosure. In addition, in this specification, the term “SRS transmission configuration information” may be used interchangeably with the term “SRS configuration information”.

Referring to FIG. 4, a base station 405 may transmit an RRCRelease message 410 to a UE 410. The base station 405 may configure (or indicate) the UE 405 to transmit an SRS in an RRC_INACTIVE state while transitioning the UE 401 to the RRC_INACTIVE state through transmission of the RRCRelease message to the UE 405.

In order to configure (or indicate) the UE to transmit an SRS in the RRC_INACTIVE state for position estimation of the UE, the base station may include, in the RRCRelease message 410, SRS transmission configuration information (e.g., SRS-PosRRC-Inactive) to be used by the UE 401 in the RRC_INACTIVE state. The SRS transmission configuration information may include at least one of SRS transmission resource configuration information (SRS-PosConfig) and configuration information of a bandwidth part (BWP) on which the SRS is to be transmitted. In this case, a serving base station 405 may configure a range in which the corresponding SRS transmission configuration is valid (referred to as a “validity area” in the disclosure). More specifically, the base station 405 may include validity area information in the RRCRelease message 410 and transmit the information. The validity area may be configured in the unit of an SRS-PosRRC-InactiveConfig, SRS-PosResourceSet, or SRS-POSResource included in the RRCRelease message 410. In other words, the SRS-PosRRC-InactiveConfig, SRS-PosResourceSet, or SRS-POSResource configuration information may be associated with a specific validity area. The validity area may be configured in the form of a list of cells, and each item in the list may include an indicator (e.g., a combination of at least one of NR Cell Global ID, PCI, and NR-ARFCN) indicating each cell. When the validity area is configured in the form of the list of cells as described above, a manner by which the UE interprets the validity area may be one of the following two.
1) When a current serving cell is one of cells included in a cell list representing a validity area, the UE may determine that the UE is within the validity area.
2) When the UE may receive a downlink reference signal (e.g., SSB, DL-PRS, etc.) from all cells included in a cell list representing a validity area, the UE may determine that the UE is within the validity area.

The UE having received the RRCRelease message 410 including the SRS transmission configuration information may perform SRS transmission 415 even in the RRC_INACTIVE state, based on the configured information. In this case, even when, due to the movement of the UE, the UE reselects a cell other than the cell through which the RRCRelease message 410 including the SRS transmission configuration information has been transmitted (402), if the UE is located within the validity area associated with the SRS configuration information currently being used, the UE 401 may continue to perform SRS transmission by using the corresponding SRS configuration information.

When the UE 401 is configured to transmit an SRS in the RRC_INACTIVE state, the UE 401 may perform only SRS transmission without performing operations that the UE is required to perform in an RRC_CONNECTED state. More specifically, when the UE 401 performs SRS transmission in the RRC_INACTIVE state, the UE may perform only SRS transmission without operations (e.g., physical downlink control channel (PDCCH) monitoring, beam management operation, channel estimation operation, etc.) that the UE is required to perform in the RRC_CONNECTED state, and thus the amount of power consumed by the UE for position estimation of the UE 401 can be reduced.

The serving base station 405 and neighboring base stations 406 and 407 may receive an SRS transmitted by the UE 401 and then transmit an SRS measurement result to an LMF. The LMF may estimate the position of the UE, based on the transmitted SRS reception (or measurement) result.

Meanwhile, the UE may stop SRS transmission when a timing advance (TA) value used for SRS transmission is invalid. The TA value may refer to information (or value) used to adjust a time at which a signal arrives at a base station when the UE transmits the signal through an uplink. If multiple UEs located at different distances from the base station transmit uplink signals with reference to their respective downlink signal synchronization, the signal transmitted by each UE may arrive at the base station at a different time due to the difference in propagation delay time, which may cause interference between the signals. In particular, in an OFDM demodulation scheme, severe interference between OFDM symbols may occur when time synchronization is not properly achieved. Therefore, in order to prevent the above-described problem, the base station may estimate a propagation delay time between the base station and the UE and configure an appropriate TA value for each UE. By configuring an appropriate TA value for each UE, the base station may adjust an uplink signal transmission time point of each UE and prevent interference between uplink signals.

The UE may determine that a TA value used for SRS transmission in the RRC_INACTIVE state is invalid if the TA value corresponds to at least one of the three cases described below.
1) When an inactivePosSRS-TimeAlignmentTimer expires.

The inactivePosSRS-TimeAlignmentTimer may be started at a time point when SRS transmission in an RRC_INACTIVE state is configured through the RRCRelease message 410, and may be restarted at a time point when a TA value is updated (e.g., a time point when the base station indicates a new TA value through a Timing Advance Command MAC CE). Therefore, when TA value update is not performed for a predetermined time (e.g., an inactivePosSRS-TimeAlignmentTimer configuration value), the inactivePosSRS-TimeAlignmentTimer expires and the UE may determine that the TA value is invalid.
2) When an RSRP value of a pathloss reference signal changes by an amount greater than or equal to an inactivePosSRS-RSRP-ChangeThreshold value compared to a reference value.

The inactivePosSRS-RSRP-ChangeThreshold may be configured together when the UE is configured to transmit an SRS in an RRC_INACTIVE state through the RRCRelease message 410. The UE may store, as a reference value, an RSRP value of a pathloss reference signal measured at a time point when TA is last updated. The pathloss reference signal may be a downlink reference signal transmitted from the serving base station 405 or the neighboring base stations 406 and 407, and may also be configured for the UE through the RRCRelease message. Thereafter, if the amount of change in the RSRP value of the current pathloss reference signal compared to the stored RSRP reference value becomes larger than an inactivePosSRS-RSRP-ChangeThreshold value, the UE may determine that a TA value is invalid. That is, when the change in the RSRP value of the pathloss reference signal is greater than or equal to a predetermined level after the TA value update, it may indicate that a significant change in the distance between the UE and the base station has occurred, and thus the UE may determine that the TA value is no longer valid.

The inactivePosSRS-TimeAlignmentTimer and inactivePosSRS-RSRP-ChangeThreshold value used for the TA validity verification may be included together in the SRS transmission configuration information in the RRC_INACTIVE state and transmitted to the UE 401 through the RRCRelease message 410.
3) When the UE reselects another cell.

When a reselection condition to another cell is satisfied due to the movement of the UE in an RRC_INACTIVE state, the UE may reselect a new cell. When the UE performs cell reselection within a validity area, the UE may maintain SRS transmission (configuration) having been received through the RRCRelease message 410. However, when the UE uses a TA value used in the previous serving cell to transmit an SRS within the coverage of a newly selected cell, significant interference may occur in uplink signal reception of the newly selected cell. Therefore, the UE may determine that the TA value used in the previous serving cell is no longer valid.

When it is determined that the TA value used by the UE for SRS transmission in the RRC_INACTIVE state is invalid since the TA value corresponds to at least one of the three cases described above, the UE may stop SRS transmission in the RRC_INACTIVE state. In this case, the base stations 405, 406, and 407 which have been measuring the SRS transmitted by the UE for position estimation of the UE may fail to measure the SRS. Thereafter, a network may attempt to perform SRS transmission configuration again for position estimation of the UE, and in this case, the UE is required to transition to the RRC_CONNECTED state to receive the corresponding SRS transmission configuration information again. In this case, the transition of the UE to the RRC_CONNECTED state may be a major factor which increases the power consumption of the UE during a position estimation process of the UE. Therefore, the disclosure proposes a method for updating a TA value in an RRC_INACTIVE state through a random access process when the TA value is invalid.

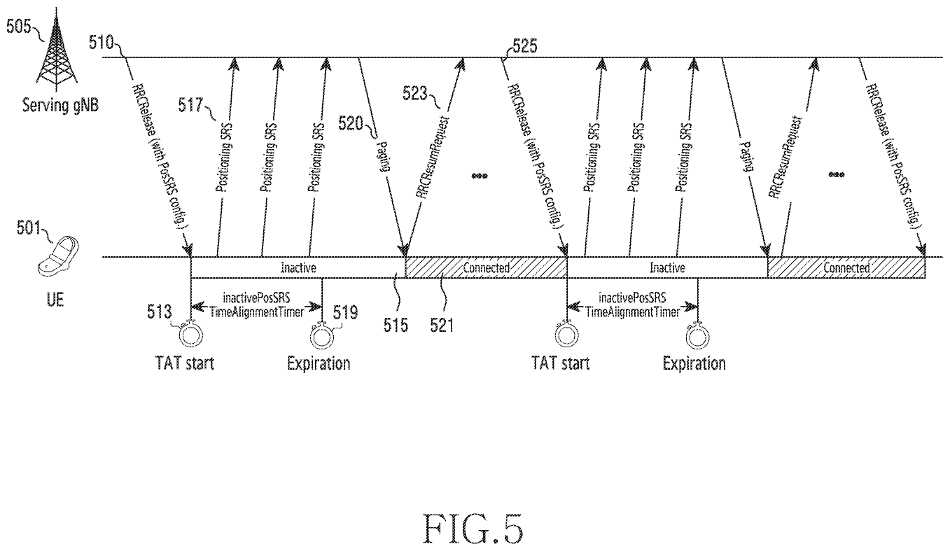

FIG. 5 is a diagram illustrating a procedure in which, when a timing advance timer (TAT) expires during SRS transmission by a UE in an RRC_INACTIVE state, the UE transitions to an RRC_CONNECTED state and receives a new SRS transmission configuration, according to an embodiment of the disclosure.

Referring to FIG. 5, a base station 505 may indicate SRS transmission while transitioning a UE 501 to an RRC_INACTIVE state 515 through an RRCRelease 510 message. The UE may start a TAT 513 related to SRS transmission at a time point of receiving the RRCRelease message. The UE may perform SRS transmission 517 to be used for position estimation according to a configuration in the RRCRelease message. Thereafter, when the TAT expires, the UE may determine that a TA value used for SRS transmission is no longer valid, and may stop SRS transmission. Thereafter, base stations which have been receiving the SRS transmitted by the UE for position estimation of the UE may report an SRS reception failure to an LMF. The LMF may request a serving base station to perform SRS transmission configuration of the UE again in order to allow the UE to perform SRS transmission again. The serving base station may indicate the UE to transition to an RRC_CONNECTED state through a paging message in order to transmit SRS transmission configuration information to the UE again. The UE having received the paging message transmitted by the serving base station may transmit an RRCResumeRequest message 523 and then transition to an RRC_CONNECTED state 521 so as to exchange necessary data with the base station. Thereafter, the base station may indicate the UE to transition to the RRC_INACTIVE state again and transmit an SRS through an RRCRelease message 525. As in the above example, if the UE has no means to update the TA value in the RRC_INACTIVE state, the UE may repeatedly perform an inefficient operation of stopping SRS transmission according to the expiration of the TAT and transitioning to the RRC_CONNECTED state to receive a new SRS transmission configuration. Such an inefficient UE operation may unnecessarily increase the power consumption of the UE and delay a position estimation procedure. Therefore, the disclosure proposes a method for updating a TA value in an RRC_INACTIVE state through a random access process when the TA value is invalid.

FIG. 6 is a diagram illustrating a procedure in which a UE updates a TA value through contention-based random access (CBRA) in an RRC_INACTIVE state, according to an embodiment of the disclosure.

Referring to FIG. 6, a UE 601 may update a TA value used for SRS transmission in an RRC_INACTIVE state through a CBRA procedure with a serving cell 605. In other words, the UE 601 may update a TA value (more specifically, a TA value corresponding to a timing advance group associated with SRS transmission) used for SRS transmission through a random access procedure with the serving cell 605. Detailed operations for each step may be described as follows.
UE Capability exchange 609: The UE 601 may exchange UE capability information with the serving cell 605. In this case, the UE may report to the serving cell whether the UE may perform SRS transmission in the RRC_INACTIVE state or whether the UE may update the TA value through a random access procedure in the RRC_INACTIVE state.
RRCRelease 610: The UE 601 may receive, from the serving cell 605 through an RRCRelease message 610, SRS transmission configuration information (e.g., SRS-PosRRC-InactiveConfig) for transmitting an SRS in the RRC_INACTIVE state.
SRS Tx in RRC_INACTIVE 611: The UE 601 may perform SRS transmission in the RRC_INACTIVE state, based on the SRS transmission configuration information received in step 610.
Trigger TA update 612: When it is determined that the TA value used for performing SRS transmission in the RRC_INACTIVE state is no longer valid, the UE 601 may start the random access procedure to update the TA value. In other words, as described above with reference to FIG. 4, when an inactivePosSRS-TimeAlignmentTimer expires, an RSRP value of a pathloss reference signal changes by an amount greater than or equal to an inactivePosSRS-RSRP-ChangeThreshold value compared to a reference value, or the UE reselects a cell other than the cell from which the UE has received the RRC_Release message, the UE 601 may start the random access procedure to update the TA value. For convenience of explanation, although FIG. 6 illustrates only a case in which the UE 601 performs random access to the serving cell 605 having transmitted the RRCRelease message in step 610. However, when the UE has actually performed cell reselection, it is noted that the TA value may also be updated by performing the following procedures 615 to 621 with the newly reselected serving cell, rather than with the serving cell having transmitted the RRCRelease message in step 610.
SIB 1 613: A UE 701 may receive a system information block (SIB) 1 message transmitted by the serving cell to which the UE intends to perform random access, and then obtain common random access configuration (e.g., RACH-ConfigCommon) information included in the SIB 1. Thereafter, the UE may perform CBRA and update the TA value through the following procedures 615 to 625 by using the random access configuration information.
Msg1. Preamble 615: The UE 601 may start the random access procedure for updating the TA value by transmitting a preamble (or random access preamble) to the serving cell 605. In this case, the UE may use a resource (e.g., a preamble) that is not associated with a specific feature (e.g., reduced capability (RedCap), network slice AS groups (NSAG), small data transmission (SDT), MSG3 repetition, etc.) among random access resources defined in the RACH-ConfigCommon information received in step 613, and such a preamble may be transmitted through a physical random access channel (PRACH).
Msg2. RAR 617: The serving cell 605 may receive the preamble from the UE 601 in step 615 and then respond through a random access response (RAR) message. The RAR message may include time/frequency resources (that is, a UL grant for uplink data transmission) for transmitting Msg3, along with a timing advance command indicating a TA value to be used by the UE when transmitting Msg3 in step 615. The UE may apply the timing advance command to a TAG to which the serving cell belongs. In other words, the UE may update the TA value used for SRS transmission.
Case 1 618: The random access procedure for updating the TA in step 612 may be triggered by an RRC layer. More specifically, when the TA value for SRS transmission is no longer valid, a MAC layer may report to the RRC layer that the TA value is invalid. When the RRC layer receives, from the MAC layer, information indicating that the TA value for SRS transmission is no longer valid or when cell reselection occurs, the RRC layer may trigger the random access procedure for updating the TA value by generating an RRCResumeRequest message and delivering the message down to the MAC layer. In this case, by specifying a resumeCause value in the RRCResumeRequest message as “TA-update”, a serving base station may identify that the random access procedure triggered by the UE is for TA update.
Msg3. ResumeRequest 619: The UE 601 may transmit an RRC ResumeRequest message as Msg3 by using timing advance command information and UL grant information included in the RAR received in step 617. In this case, in order to indicate that the random access procedure currently being performed by the UE is for TA update, a newly defined resumeCause (e.g., TA-update) may be included in the ResumeRequest message.
Msg4. RRCRelease 621: The serving cell 605 may identify that the UE 601 has started the random access procedure and an RRC connection resume procedure only for TA update, through resumeCause information in the ResumeRequest message transmitted by the UE 601. Through this, the base station may transition the UE to the RRC_INACTIVE state again by transmitting the RRCRelease message without performing an unnecessary RRC connection resume procedure. In addition, upon identifying that the UE has started the random access procedure and the RRC connection resume procedure only for TA update, the base station may not redundantly include, in the RRCRelease message transmitted at this time, UE configuration information in the RRC_INACTIVE state, which has been unnecessarily transmitted through the RRCRelease message in step 610. Specifically, when the base station does not include configuration information (SRS-PosRRC-InactiveConfig) related to SRS transmission in the RRC_INACTIVE state in the RRCRelease message 621, the UE 601 may reuse the configuration information having been received in the RRCRelease received in step 610. In addition, the base station may include, in the RRCRelease message 621, an indicator for explicitly indicating the UE to reuse the SRS transmission-related configuration information (SRS-PosRRC-InactiveConfig) previously transmitted in step 610.

In addition, the UE 601 may perform a contention resolution procedure through reception of Msg4 including a contention resolution identity MAC CE. More specifically, the UE may determine that the contention resolution procedure has been successfully completed when the contention resolution identity MAC CE included in Msg4 matches the Msg3 (RRCResumeRequest) message having been transmitted in step 619. When the contention resolution procedure is successful, the UE may determine that the TA update has been successfully completed, and restart the inactivePosSRS-TimeAlignmentTimer. Conversely, when the contention resolution procedure fails, the UE may identify that the RAR message having been transmitted by the serving cell in step 617 has been transmitted to another UE and may cancel the application of the timing advance command having been performed for the TAG by using a timing advance command (TAC) value included in the corresponding RAR message. (That is, the TA value may be restored (or changed) to a value before the TAC application.)
Case 2 622: The random access procedure for updating the TA in step 612 may be triggered by the MAC layer. More specifically, when the TA value for SRS transmission is no longer valid, the MAC layer itself may trigger the random access procedure for updating the TA value. However, when the TA value becomes invalid due to cell reselection, random access may be triggered by the RRC layer in a manner of generating a common control channel (CCCH) message (e.g., RRCResumeRequest message) as in Case 1 618.
Msg3. C-RNTI MAC CE 619: The UE 601 may use the timing advance command information and the UL grant information included in the RAR received in step 617 to include, in a C-RNTI MAC CE, a cell radio network temporary identifier (C-RNTI) value to be used for contention resolution, and transmit the C-RNTI MAC CE through Msg3. In this case, as the C-RNTI value, a C-RNTI value received from the serving cell (or PCell) at the time point when the UE receives the RRCRelease message in step 610 may be used. For reference, the C-RNTI value is a value which is included in a UE Inactive AS context and is stored and retained by the UE even in the RRC_INACTIVE state. However, since the C-RNTI is a value valid only within the serving cell having transmitted the RRCRelease message in step 610, the C-RNTI cannot be used for contention resolution when the UE performs cell reselection after receiving the RRCRelease message. Therefore, when the TA value becomes invalid due to cell reselection, random access may be triggered by the UE 601 through a manner in which the RRC layer generates a CCCH message (e.g., an RRCResumeRequest message), as in Case 1 618, and the CCCH message may be transmitted as Msg3.
Msg4. DCI addressed to the C-RNTI 625: The serving cell 605 may receive a C-RNTI message transmitted by the UE 601 in step 623, and then transmit a DCI addressed to the C-RNTI for contention resolution. The UE may successfully complete the contention resolution procedure when receiving the DCI as Msg4. When the contention resolution procedure is successful as described above, the UE may determine that the TA update has been successfully completed, and restart the inactivePosSRS-TimeAlignmentTimer. Conversely, when the contention resolution procedure fails, the UE may identify that the RAR message having been transmitted by the serving cell in step 617 has been transmitted to another UE and may cancel the application of the timing advance command having been performed for the TAG by using a timing advance command (TAC) value included in the corresponding RAR message. (That is, the TA value may be restored (or changed) to a value before the TAC application.)

When the UE does not receive a response to the preamble transmitted in step 615, the UE may retransmit the preamble. Then, when the number of preamble transmissions by the UE exceeds a specific threshold (e.g., preambleTransMax), the UE may determine that the random access procedure for updating the TA value has failed. If the corresponding random access procedure has been triggered by the MAC layer for TA update, the MAC layer may notify the RRC layer to release the SRS transmission configuration having been received in step 610. The operation may be represented as shown in Table 1 below

```
TABLE 1
1> if ra-ResponseWindow configured in RACII-ConfigCommon expires, and if
the Random Access Response containing Random Access Preamble
identifiers that matches the transmitted PREAMBLE_INDEX has not been
received:
  2> consider the Random Access Response reception not successful;
  2> increment PREAMBLE_TRANSMISSION_COUNTER by 1;
  2> if PREAMBLE_TRANSMISSION_COUNTER = preambleTransMax + 1:
    3> if the Random Access Preamble is transmitted on the SpCell:
      4> indicate a Random Access problem to upper layers;
      4> if this Random Access procedure was triggered for SI request :
        5>consider the Random Access procedure unsuccessfully
completed.
      4> if this Random Access procedure was triggered by MAC
sublayer for TA update:
        5> consider the Random Access procedure unsuccessfully
completed.
        5> if inactivePosSRS-TimeAlignmentTimer is configured and
has been expired:
          6> notify RRC to release Positioning SRS for RRC_INACTIVE
configuration(s).
    3>else if the Random Access Preamble is transmitted on an SCell:
      4>consider the Random Access procedure unsuccessfully
completed.
```

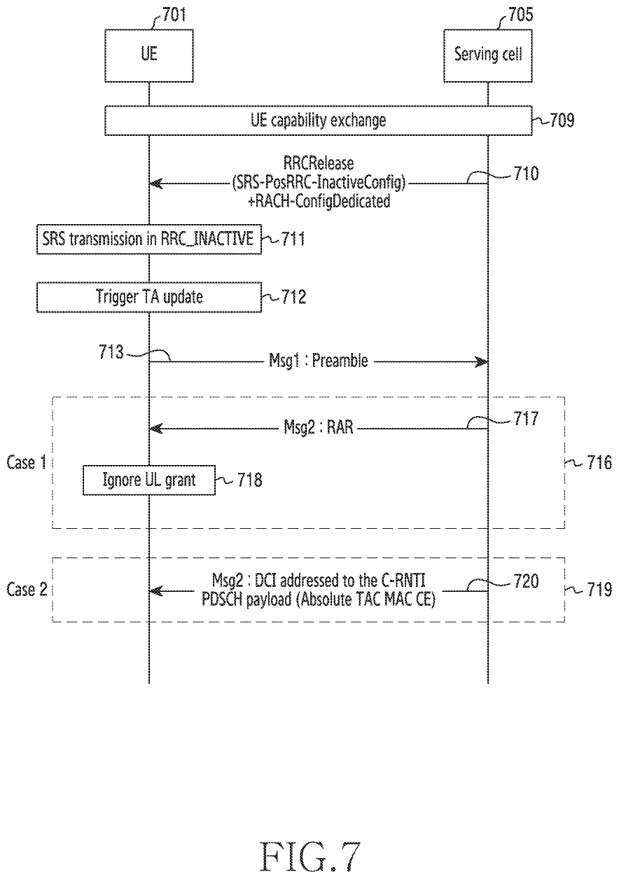

FIG. 7 is a diagram illustrating a procedure in which a UE updates a TA value through contention-free random access (CFRA) in an RRC_INACTIVE state, according to an embodiment of the disclosure.

Referring to FIG. 7, a UE 701 may update a TA value used for SRS transmission in an RRC_INACTIVE state through a CFRA procedure with a serving cell 705. In other words, the UE may update a TA value (more specifically, a TA value corresponding to a timing advance group associated with SRS transmission) used for SRS transmission through a random access procedure with the serving cell. When the TA value is updated through the CFRA procedure, Msg3 and Msg4 transmission/reception procedures for contention resolution, as shown in FIG. 6, are not required, so that the UE may update the TA value in a shorter time. Therefore, time and energy consumed for updating the TA value in the RRC_INACTIVE state may be reduced. Detailed operations for each step may be described as follows.
UE Capability exchange 709: The UE 701 may exchange UE capability information with the serving cell 705. In this case, the UE may report to the serving cell whether the UE may perform SRS transmission in the RRC_INACTIVE state, whether the UE may perform CFRA in the RRC_INACTIVE state (in other words, whether the UE may receive a configuration of a dedicated RA resource through an RRCRelease message and perform CFRA in the RRC_INACTIVE state), or whether the UE may update the TA value through a random access procedure in the RRC_INACTIVE state.
RRCRelease 710: The UE 701 may receive, from the serving cell 705 through an RRCRelease message 710, SRS transmission configuration information (e.g., SRS-PosRRC-InactiveConfig) for transmitting an SRS in the RRC_INACTIVE state. In addition, the UE 701 may receive, from the serving cell 705 through the RRCRelease message 710, a random access resource configuration (e.g., RACH-ConfigDedicated) allocated to perform the CFRA procedure for updating the TA value in the RRC_INACTIVE state. In this case, when a range (validity area) in which the corresponding SRS transmission configuration is valid is configured together with the SRS configuration information, a separate CFRA resource (e.g., RACH-ConfigDedicated) and a C-RNTI value may be configured for each cell corresponding to the validity area. Thereafter, the UE may perform contention-free random access and update the TA value through the following procedures 713 to 720 by using the random access configuration information.
SRS Tx in RRC_INACTIVE 711: The UE 701 may perform SRS transmission in the RRC_INACTIVE state, based on the SRS transmission configuration information received in step 710.
Trigger TA update 712: When it is determined that the TA value used for performing SRS transmission in the RRC_INACTIVE state is no longer valid, the UE 701 may start the random access procedure to update the TA value. In other words, as described above with reference to FIG. 4, when an inactivePosSRS-TimeAlignmentTimer expires, an RSRP value of a pathloss reference signal changes by an amount greater than or equal to an inactivePosSRS-RSRP-ChangeThreshold value compared to a reference value, or the UE reselects a cell other than the cell from which the UE has received the RRC_Release message, the UE 701 may start the random access procedure to update the TA value. In this case, the UE may start the random access procedure only when the UE has been allocated a resource for performing CFRA to update the TA value in the RRC_INACTIVE state in the RRCRelease message received in the step 710.

For convenience of explanation, although FIG. 7 illustrates only a case in which the UE 701 performs random access to the serving cell 705 having transmitted the RRCRelease message in step 710. However, when the UE has actually performed cell reselection, it is noted that the TA value may also be updated by performing the following procedures 713 to 720 with the newly reselected serving cell, rather than with the serving cell having transmitted the RRCRelease message in step 710.

When the reselected new serving cell is a cell included in the validity area of the SRS transmission configuration information configured through the RRCRelease message received in step 710, and there are a CFRA resource and a C-RNTI value allocated separately for the corresponding cell, the UE may perform random access to the reselected cell by using the corresponding resource and then update the TA value.
Msg1. Preamble 713: The UE 701 may start the random access procedure for updating the TA value by transmitting a preamble to the serving cell 705. In this case, when a CFRA resource defined in RACH-ConfigDedicated information received in step 713 exists, the UE may transmit the preamble by using the corresponding resource, and the preamble may be transmitted through a PRACH.
Case 1 716: When the serving cell transmits an RAR message as Msg2.
Msg2. RAR 717: The serving cell 705 may receive the preamble from the UE 701 in step 713 and then transmit an RAR message in response to the received preamble. The RAR message may include a timing advance command indicating the TA value. The UE may apply the timing advance command to a TAG to which the serving cell belongs. In other words, the UE may update the TA value used for SRS transmission. In this case, the UE may determine that the TA update has been successfully completed, and restart the inactivePosSRS-TimeAlignmentTimer. The operation may be represented as shown in Table 2 below.

```
TABLE 2
1>when a Timing Advance Command is received in a Random Access
Response message for a Serving Cell belonging to a TAG or in a MSGB
for an SpCell:
  2>if the Random Access Preamble was not selected by the MAC entity
among the contention-based Random Access Preamble:
    3>apply the Timing Advance Command for this TAG;
    3>start or restart the timeAlignmentTimer associated with this
TAG.
for TA update and SRS transmission in RRC_INACTIVE is
configured:
      4>start or restart the inactivePosSRS-TimeAlignment Timer
associated with this TAG.
```

Additionally, the RAR message may include time/frequency resources (that is, a UL grant for uplink data transmission) for the UE to transmit uplink data. If the corresponding random access procedure has been performed for TA update in the RRC_INACTIVE state, the UE may ignore the UL grant (718). Such an operation may be represented as shown in Table 3 below.

TABLE 3

```
5>if the Random Access procedure for an
SCell is performed on uplink carrier where
pusch-Config is not configured; or
5>if the Random Access procedure was
triggered by MAC sublayer for TA update:
  6>ignore the received UL grant.
5>else:
  6>process the received UL grant value and
indicate it to the lower layers.
```

Case 2 619: When the serving cell transmits a DCI addressed to C-RNTI as Msg2.
Msg2. DCI addressed to the C-RNTI 717: The serving cell 705 may receive the preamble from the UE 701 in step 713 and then transmit a DCI addressed to C-RNTI as Msg2. In this case, as the C-RNTI value, a C-RNTI value received from the serving cell (or PCell) at the time point when the UE receives the RRCRelease message in step 710 may be used. For reference, the C-RNTI value is a value which is included in a UE Inactive AS context and is stored and retained by the UE even in the RRC_INACTIVE state. The DCI may schedule downlink data transmitted through a physical downlink shared channel (PDSCH), and the corresponding downlink data may include an absolute timing advance command MAC CE indicating the TA value. The UE may apply the absolute timing advance command to the TAG to which the serving cell belongs. In other words, the UE may update the TA value used for SRS transmission. In this case, the UE may determine that the TA update has been successfully completed, and restart the inactivePosSRS-TimeAlignmentTimer. The operation may be represented as shown in Table 4 below.

```
TABLE 4
1> if the contention free Random Access Preamble for TA update was
transmitted by the MAC entity:
  2> start the ra-ResponseWindow configured in RACH-ConfigCommon at
the first PDCCH occasion as specified in TS 38.213 [6] from the end
of the Random Access Preamble transmission.
  2> monitor the PDCCH of the PCell for Random Access Response(s)
identified by the C-RNTI as stored in UE Inactive AS context as
specified in TS 38.331 [5] while the ra-ResponseWindow is running.
...
1>if PDCCH transmission is addressed to the C-RNTI; and
1> if a downlink assignment has been received on the PDCCH for the C-
RNTI and the received TB is successfully decoded; and
1> if the contention-free Random Access Preamble for TA update was
transmitted by the MAC entity:
  2> if the MAC PDU contains the Absolute Timing Advance Command MAC
CE:
    3> process the received Timing Advance Command (see clause 5.2);
    3> consider the Random Access procedure successfully completed.
1>when an Absolute Timing Advance Command is received in response to
the contention-free Random Access Preamble transmission for TA
update as specified in clause 5.1.4a:
  2>apply the Timing Advance Command for PTAG;
  2> if there is ongoing Positioning SRS Transmission in RRC_INACTIVE
as in clause 5.26:
    3> start or restart the inactivePosSRS-TimeAlignment Timer
associated with the indicated TAG.
  2> else:
    3>start or restart the timeAlignment Timer associated with PTAG.
```

When the UE does not receive a response to the preamble transmitted in step 713, the UE may retransmit the preamble. Then, when the number of preamble transmissions by the UE exceeds a specific threshold (e.g., preambleTransMax), the UE may determine that the random access procedure for updating the TA value has failed. In this case, a MAC layer may notify an RRC layer to release the SRS transmission configuration received in step 710. The operation may be represented as shown in Table 5 below.

```
TABLE 5
1> if ra-ResponseWindow configured in RACH-ConfigCommon expires, and if
the Random Access Response containing Random Access Preamble
identifiers that matches the transmitted PREAMBLE_INDEX has not been
received:
  2>consider the Random Access Response reception bot successful;
  2>increment PREAMBLE_TRANSMISSION_COUNTER by 1;
  2>if PREAMBLE_TRANSMISSION_COUNTER =preambleTransMax +1:
    3>if the Random Access Preamble is transmitted on the SpCell:
      4>indicate a Random Access problem to upper layers;
      4>if this Random Access procedure was triggered for SI request :
5>consider the Random Access procedure unsuccessfully
completed.
      4>if this Random Access procedure was triggered by MAC
sublayer for TA update:
        5>consider the Random Access procedure unsuccessfully
completed.
        5>if inactivePosSRS-TimeAlignmentTimer is configured and
has been expired:
          6>notify RRC to release Positioning SRS for RRC INACTIVE
configuration(s).
    3>else if the Random Access Preamble is transmitted on an SCell:
      4>consider the Random Access procedure unsuccessfully
completed.
```

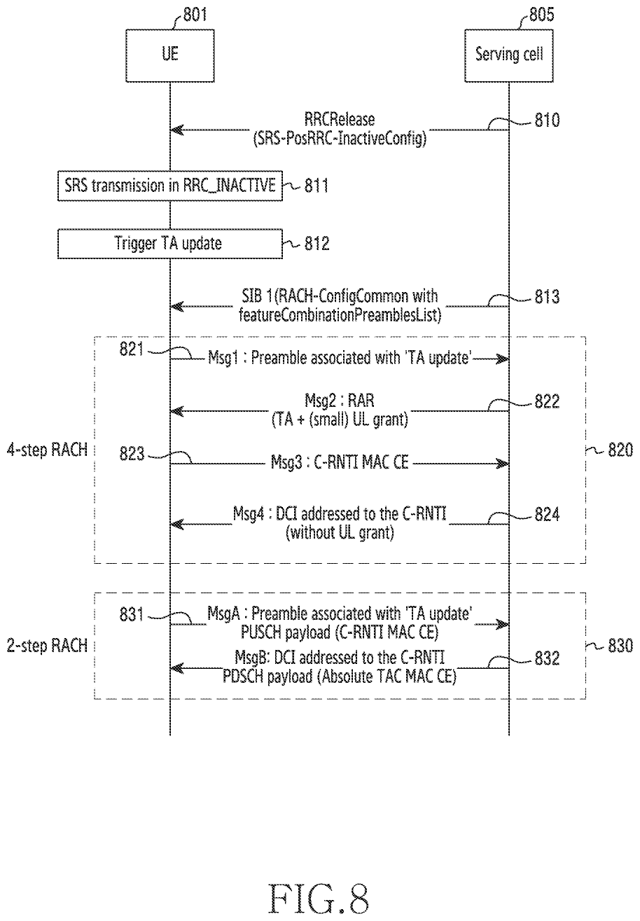

FIG. 8 is a diagram illustrating a method for performing CBRA and updating a TA value by a UE in an RRC_INACTIVE state, by using a random access resource configured for timing advance (TA) update, according to an embodiment of the disclosure.

Referring to FIG. 8, a UE 801 may update a TA value used for SRS transmission in an RRC_INACTIVE state through a CBRA procedure with a serving cell 805. In other words, the UE 801 may update a TA value (more specifically, a TA value corresponding to a timing advance group associated with SRS transmission) used for SRS transmission through a random access procedure with the serving cell. In this case, when a resource (e.g., featureCombinationPreamblesList) associated with TA update is included in a common random access resource (e.g., RACH-ConfigCommon or MagA-ConfigCommon) provided by the serving cell, the UE may perform the random access procedure for updating the TA value by using the corresponding resource.

When the UE performs random access through a resource associated with TA update, the serving cell may identify that the corresponding random access procedure has been triggered for the purpose of TA update, and thus perform the random access procedure more efficiently. For example, in a 4-step random access procedure 820 described below, the serving cell may identify that the UE has triggered the corresponding random access procedure only for TA update, and may configure the size of a UL grant included in Msg2 822 to exactly match the size of a C-RNTI MAC CE 823 to be transmitted as Msg3, or may configure the size of a UL grant indicated by a DCI 824 to be transmitted as Msg4 to 0. Therefore, the energy consumption of the UE and the resource consumption of the serving cell may be reduced. Detailed operations for each step may be described as follows.
UE Capability exchange (not shown): The UE 801 may exchange UE capability information with the serving cell 805. In this case, the UE may report to the serving cell whether the UE may perform SRS transmission in the RRC_INACTIVE state, whether the UE may update the TA value through a random access procedure in the RRC_INACTIVE state, or whether the UE may understand and use a resource configuration associated with TA update when performing the random access.
RRCRelease 810: The UE 801 may receive, from the serving cell 805 through an RRCRelease message 810, SRS transmission configuration information for transmitting an SRS in the RRC_INACTIVE state.
SRS Tx in RRC_INACTIVE 811: The UE 801 may perform SRS transmission in the RRC_INACTIVE state, based on the SRS transmission configuration information received in step 810.
Trigger TA update 812: When it is determined that the TA value used for performing SRS transmission in the RRC_INACTIVE state is no longer valid, the UE 801 may start a random access procedure to update the TA value. In other words, as described above with reference to FIG. 4, when an inactivePosSRS-TimeAlignmentTimer expires, an RSRP value of a pathloss reference signal changes by an amount greater than or equal to an inactivePosSRS-RSRP-ChangeThreshold value compared to a reference value, or the UE reselects a cell other than the cell from which the UE has received the RRC_Release message, the UE 801 may start the random access procedure to update the TA value. For convenience of explanation, although FIG. 8 illustrates only a case in which the UE 801 performs random access to the serving cell 805 having transmitted the RRCRelease message in step 810. However, when the UE has actually performed cell reselection, it is noted that the TA value may also be updated by performing the following procedures 615 to 621 with the newly reselected serving cell, rather than with the serving cell having transmitted the RRCRelease message in step 810.
SIB 1 813: The UE 801 may receive an SIB 1 message transmitted by the serving cell to which the UE intends to perform random access, and then obtain common random access configuration (e.g., RACH-ConfigCommon or msgA-ConfigCommon) information included in the corresponding message. In this case, a random access resource (e.g., a preamble) associated with TA update may be separately configured within the corresponding random access configuration. Thereafter, the UE may perform contention-based random access and update the TA value through the following procedures 821 to 832 by using the random access configuration information. As described above, in order to associate a specific random access preamble resource with a TA update function, a new field (e.g., TA-Update-rxx) may be defined in the form of a 1-bit indicator in a FeatureCombination IE defined in the RRC specification, as shown in Table 6.

TABLE 6
FeatureCombination-r17 ::= SEQUENCE {

| | | | |
|---|---|---|---|
| redCap-r17 | ENUMERATED {true} | OPTIONAL, | -- Need R |
| smallData-r17 | ENUMERATED {true} | OPTIONAL, | -- Need R |
| nsag-r 17 | NSAG-List-r17 | OPTIONAL, | -- Need R |
| msg3-Repetitions-r17 | ENUMERATED {true} | OPTIONAL, | -- Need R |
| TA-Update-rxx | ENUMERATED {true} | OPTIONAL, | -- Need R |
| spare3 | ENUMERATED {true} | OPTIONAL, | -- Need R |
| spare2 | ENUMERATED {true} | OPTIONAL, | -- Need R |
| spare1 | ENUMERATED {true} | OPTIONAL | -- Need R |
| } | | | |

4-step RA 820: The UE 801 may perform 4-step random access to the serving cell 805 through the following steps 821 to 824 for TA update.
Msg1. Preamble 821: The UE 801 may start the random access procedure for updating the TA value by transmitting a preamble to the serving cell 805. In this case, when there is a resource (e.g., a preamble) associated with TA update among random access resources defined in RACH-ConfigCommon information received in step 813, the UE may perform random access by using the corresponding resource. Otherwise, the UE 801 may use a resource (e.g., a preamble) which is not associated with a specific feature (e.g., RedCap, NSAG, SDT, MSG3 repetition, etc.).
Msg2. RAR 822: The serving cell 805 may receive the preamble from the UE 801 in step 815 and then respond through an RAR message. The RAR message may include time/frequency resources (that is, a UL grant for uplink data transmission) for transmitting Msg3, along with a timing advance command indicating a TA value to be used by the UE when transmitting Msg3 in step 823. The UE may apply the timing advance command to a TAG to which the serving cell belongs. In other words, the UE may update the TA value used for SRS transmission. In addition, the serving cell may determine that the UE has started the random access procedure for TA update after receiving the preamble transmitted by the UE in step 821. Therefore, the size of the UL grant included in the RAR message may be accurately configured to match a size required for the UE to transmit a C-RNTI MAC CE for contention resolution in step 823 below.
Msg3. C-RNTI MAC CE 823: The UE 801 may transmit a C-RNTI value to be used for contention resolution through a C-RNTI MAC CE as Msg3 by using timing advance command information and UL grant information included in the RAR received in step 822. In this case, as the C-RNTI value, a C-RNTI value received from the serving cell (or PCell) at the time point when the UE receives the RRCRelease message in step 810 may be used. For reference, the C-RNTI value is a value which is included in a UE Inactive AS context and is stored and retained by the UE even in the RRC_INACTIVE state.

However, since the C-RNTI is a value valid only within the serving cell having transmitted the RRCRelease message in step 810, the C-RNTI cannot be used for contention resolution when the UE performs cell reselection after receiving the RRCRelease message. Therefore, when the TA value becomes invalid due to cell reselection, random access may be triggered through a manner in which an RRC layer generates a CCCH message (e.g., an RRCResumeRequest message), similar to Case 1 618 in FIG. 6, and the UE may transmit the CCCH message as Msg3. If the size of the UL grant received through the RAR message in step 822 is insufficient to transmit the CCCH message, the UE may perform the CBRA procedure by transmitting a preamble which is not associated with TA update, similar to step 615 in FIG. 6, and receive a UL grant having a size sufficient to transmit the CCCH message, similar to step 617.
Msg4. DCI addressed to the C-RNTI 824: The serving cell 805 may receive a C-RNTI message transmitted by the UE 801 in step 823, and then transmit a DCI addressed to the C-RNTI for contention resolution. In this case, the serving cell may determine that the UE has started the random access procedure for TA update after receiving the preamble transmitted by the UE in step 821, and may use the DCI only for contention resolution (e.g., without UL grant allocation). Therefore, the DCI may not include any valid UL grant information. The UE may successfully complete a contention resolution procedure when receiving the DCI as Msg4. In this case, when the random access procedure has been triggered for the purpose of TA update, the UE may consider contention resolution to be successful even when the DCI does not include a valid UL grant. When the contention resolution procedure is successful as described above, the UE may determine that the TA update has been successfully completed, and restart the inactivePosSRS-TimeAlignmentTimer. Conversely, when the contention resolution procedure fails, the UE may identify that the RAR message having been transmitted by the serving cell in step 822 has been transmitted to another UE and may cancel the application of the timing advance command having been performed for the TAG by using a timing advance command (TAC) value included in the corresponding RAR message. (That is, the TA value may be restored (or changed) to a value before the TAC application.)

When the UE does not receive a response to the preamble transmitted in step 821, the UE may retransmit the preamble. Then, when the number of preamble transmissions by the UE exceeds a specific threshold (e.g., preambleTransMax), the UE may determine that the random access procedure for updating the TA value has failed. In this case, a MAC layer may notify the RRC layer to release the SRS transmission configuration received in step 810. The operation may be represented as shown in Table 7 below.

```
TABLE 7
1> if ra-Responsefindow configured in RACH-ConfigCommon expires. and if
the Random Access Response containing Random Access Preamble
identifiers that matches the transmitted PREAMBLE_INDEX has not been
received:
  2> consider the Random Access Response reception not successful;
  2> increment PREAMBLE_TRANSMISSION_COUNTER by 1;
  2>\{ PREAMBLE_TRANSMISSION_COUNTER = preambleTransMax + 1:
    3> if the Random Access Preamble is transmitted on the SpCell:
      4> indicate a Random Access problem to upper layers;
      4> if this Random Access procedure was triggered for SI request :
        5>consider the Random Access procedure unsuccessfully
completed.
      4> if this Random Access procedure was triggered by MAC
sublayer for TA update:
        5> consider the Random Access procedure unsuccessfully
completed.
        5> if inactivePosSRS-TimeAlignmentTimer is configured and
has been expired:
          6> notify RRC to release Positioning SRS for RRC_INACTIVE
configuration(s).
    3>else if the Random Access Preamble is transmitted on an SCell:
      4>consider the Random Access procedure unsuccessfully
completed.
```

2-step RA 830: The UE 801 may perform 2-step random access to the serving cell 805 through the following steps 831 and 832 for TA update.
MsgA. Preamble+PUSCH (physical uplink shared channel) payload 830: The UE 801 may transmit a preamble and a C-RNTI MAC CE on a PUSCH resource associated with the corresponding preamble to the serving cell 805, so as to start the random access procedure for updating the TA value. In this case, as the C-RNTI value, a C-RNTI value received from the serving cell (or PCell) at the time point when the UE receives the RRCRelease message in step 810 may be used. For reference, the C-RNTI value is a value which is included in a UE Inactive AS context and is stored and retained by the UE even in the RRC_INACTIVE state. However, since the C-RNTI is a value valid only within the serving cell having transmitted the RRCRelease message in step 810, when the UE performs cell reselection after receiving the RRCRelease message, the C-RNTI cannot be used for contention resolution.

When there is a resource (e.g., a preamble and a PUSCH resource associated with the corresponding preamble) associated with TA update among random access resources defined in the MsgA-ConfigCommon information received in step 813, the UE may perform random access by using the corresponding resource. Otherwise, a resource which is not associated with a specific feature (e.g., RedCap, NSAG, SDT, MSG3 repetition, etc.) may be used.
MsgB. DCI+PDSCH payload 832: The serving cell 805 may receive the preamble and PUSCH transmission from the UE 801 in step 831 and then respond with a DCI addressed to C-RNTI as Msg2. In this case, a value having been transmitted by the UE to the serving cell in step 831 may be used as the C-RNTI value. The DCI may schedule downlink data transmitted through a PDSCH, and the corresponding downlink data may include an absolute timing advance command MAC CE indicating the TA value. After receiving the DCI, the UE may receive the absolute timing advance command MAC CE indicating the TA value on a PDSCH resource indicated by the corresponding DCI. Thereafter, the UE may apply the absolute timing advance command to the TAG to which the serving cell belongs. In other words, the UE may update the TA value used for SRS transmission. In this case, the UE may determine that the TA update has been successfully completed, and restart the inactivePosSRS-TimeAlignmentTimer.

When the UE does not receive a response to MsgA transmitted in step 831, the UE may retransmit MsgA. Then, if the number of MsgA transmissions by the UE exceeds a specific threshold (e.g., msgA-TransMax), the UE may stop the 2-step RA procedure and perform the 4-step RA procedure to update the TA value. In this case, the UE may perform the 4-step RA procedure again to update the TA value, as in step 820.

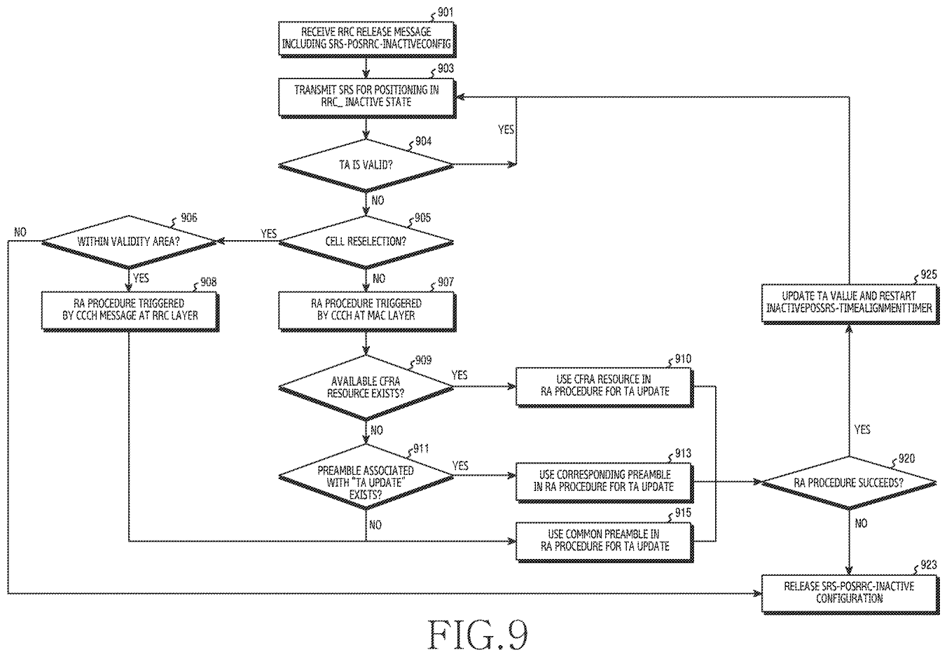

FIG. 9 is a flowchart illustrating operations when a UE receives SRS transmission configuration information in an RRC_INACTIVE state, according to an embodiment of the disclosure.

Referring to FIG. 9, a UE may perform SRS transmission while maintaining an RRC_INACTIVE state, based on configuration information (e.g., SRS-PoSRRC-InactiveConfig) for SRS transmission in the RRC_INACTIVE state included in RRCRelease. In this case, when a TA value becomes invalid, the UE may update the TA value through a random access procedure. The related detailed procedures may be described as follows.
Receive RRC Release message with SRS-PosRRC-InactiveConfig 901: The UE may receive an RRC Release message from a serving cell and transition to the RRC_Inactive state. In this case, the corresponding RRC Release message may include configuration information (SRS-PosRRC-InactiveConfig) for performing SRS transmission in the RRC_INACTIVE state for position estimation of the UE. Additionally, the RRC Release message may also include random access resource configuration (e.g., RACH-ConfigDedicated) which may be used to update the TA value through a CFRA procedure in the RRC_INACTIVE state. In addition, a range (validity area) in which the SRS transmission configuration information is valid may also be configured together, as described above with reference to FIG. 4. When the validity area is configured together as described above, RACH-ConfigDedicated and C-RNTI information available for CFRA in a corresponding cell for each cell included in the validity area may also be configured together.
Transmit SRS for positioning in RRC_Inactive state 903: The UE may perform SRS transmission for position estimation of the UE in the RRC_INACTIVE state by using the SRS-PosRRC-InactiveConfig received in step 901.
TA is valid? 904: The UE may identify whether the TA value used to perform SRS transmission in the RRC_INACTIVE state is valid. In other words, as described above with reference to FIG. 4, when an inactivePosSRS-TimeAlignmentTimer expires, or a reference signal received power (RSRP) value of a pathloss reference signal changes by an amount greater than or equal to an inactivePosSRS-RSRP-ChangeThreshold value compared to a reference value, or the UE reselects a cell other than the cell from which the UE has received the RRC Release message, the UE may determine that the TA value used for SRS transmission is no longer valid. When the UE determines that the TA value is no longer valid, the UE may proceed to step 905 to start a random access procedure for updating the TA value. Conversely, when the TA value is still valid, the UE may return to step 903 and continue performing SRS transmission in the RRC_INACTIVE state.
Cell re-selection? 905: When it is determined in step 904 that the TA value has become invalid due to cell reselection, the UE may proceed to step 906 to identify whether the cell reselected by the UE belongs to the validity area configured together with the SRS transmission configuration in step 901. Conversely, when it is determined in step 904 that the TA value has become invalid due to the expiration of the inactivePosSRS-TimeAlignmentTimer or an RSRP change greater than or equal to the inactivePosSRS-RSRP-ChangeThreshold value, the UE may proceed to step 907 to trigger an RA procedure for TA update.
RA procedure triggered by MAC layer 907: A MAC layer of the UE may trigger the random access procedure for updating the TA value by itself. In this embodiment, although the flowchart is illustrated for the representative case where the UE triggers random access when the TA value is invalid, the UE may also start the random access procedure for TA update when one or a combination of one or more of the following conditions is satisfied.
When there is an available contention-free RA resource configured for TA update.
When there is an available RA resource configured for TA update.
Any available CFRA resource? 909: When there is an available contention-free RA resource configured for TA update, the UE may proceed to step 910 and then perform the CFRA procedure by using the corresponding resource. Conversely, when there is no available contention-free RA resource configured for TA update, the UE may proceed to step 911 to identify whether a resource (e.g., a preamble) configured for the purpose of TA update exists within a common RACH resource (e.g., RACH-ConfigCommon) received through SIB1.
Use CFRA resource in the RA procedure for TA update 910: The UE performs the RA procedure for TA update by using a CFRA resource. A detailed CFRA procedure is as described in FIG. 7.
Any preambles associated with ‘TA update’? 911: The UE identifies whether the resource (e.g., the preamble) configured for the purpose of TA update exists within the common RACH resource (e.g., RACH-ConfigCommon) received through SIB1. If the corresponding resource exists, the UE proceeds to step 913 and then performs the RA procedure by using the corresponding resource. Conversely, when the resource (e.g., the preamble) configured for the purpose of TA update does not exist within the common RACH resource (e.g., RACH-ConfigCommon), the UE proceeds to step 915 to perform the RA procedure by using a resource (e.g., a preamble) which is not associated with a specific feature (e.g., RedCap, NSAG, SDT, MSG3 repetition, etc.) among random access resources defined in RACH-ConfigCommon information.
Use the preambles in the RA procedure for TA update 913: The UE performs the RA procedure by using a resource (e.g., a preamble) associated with “TA update” among the random access resources defined in the RACH-ConfigCommon information received through SIB1. A detailed RA procedure is as described in FIG. 8.
Use common preambles in the RA procedure for TA update 915: The UE performs the RA procedure by using the resource (e.g., the preamble) which is not associated with the specific feature (e.g., RedCap, NSAG, SDT, MSG3 repetition, etc.) among the random access resources defined in the RACH-ConfigCommon information received through SIB1. A detailed RA procedure is as described in FIG. 6.
Within validity area? 906: When the UE reselect a cell while performing SRS transmission in the RRC_INACTIVE state, the UE may determine whether the reselected cell is included in the validity area associated with the SRS transmission configuration currently being used. In this case, when the reselected cell is not included in the validity area associated with the SRS transmission configuration, the UE may proceed to step 923 to stop SRS transmission and release the SRS transmission configuration in the RRC_INACTIVE state received in step 901. Conversely, when the reselected cell is included in the validity area associated with the SRS transmission configuration, the UE may proceed to step 908 to start the RA procedure for TA update.
RA procedure triggered by CCCH Msg from RRC layer 908: When the TA value becomes invalid due to cell reselection, an RRC layer may generate an RRCResumeRequest message and transmit the message to the MAC layer, so as to trigger the random access procedure for updating the TA value. In this case, the RRC layer specifies a resumeCause value in the RRCResumeRequest message as “TA-update”, so that the serving cell may identify that the random access procedure triggered by the UE is for TA update. Thereafter, the UE proceeds to step 915 to perform a necessary RA procedure.

In an embodiment of the disclosure, for ease of explanation, the flowchart shows, as a representative example, only a case where, when a different cell is reselected, the UE proceeds to step 915 and performs the RA procedure by using a common preamble in the RACH-ConfigCommon information received through SIB1. However, as described in step 710 of FIG. 7, when the UE has been allocated a separate resource for performing the CFRA procedure for each cell included in the validity area in step 901, the UE may move to step 909 to identify whether there is an available CFRA resource in the current serving cell.
Success RA procedure? 920: The UE may determine whether the RA procedure performed in step 910, 913, or 915 has been successfully completed. The detailed contents regarding whether the RA procedure in each case has been successfully completed are described in FIG. 7, FIG. 8, and FIG. 6, respectively. When the UE determines that the RA procedure for TA update has been successfully completed, the UE may proceed to step 925 to update the TA value for SRS transmission and restart the inactivePosSRS-TimeAlignmentTimer. Conversely, when the RA procedure fails, the MAC layer of the UE may indicate the RRC layer to release the SRS-PosRRC-InactiveConfig information received in step 901.
Update TA value & RestartinactivePosSRS-TimeAlignmentTimer 925: The UE may update the TA value for SRS transmission and restart the inactivePosSRS-TimeAlignmentTimer.
Release SRS-PosRRC-InactiveConfig 923: The UE may release the SRS-PosRRC-InactiveConfig information received in step 901.

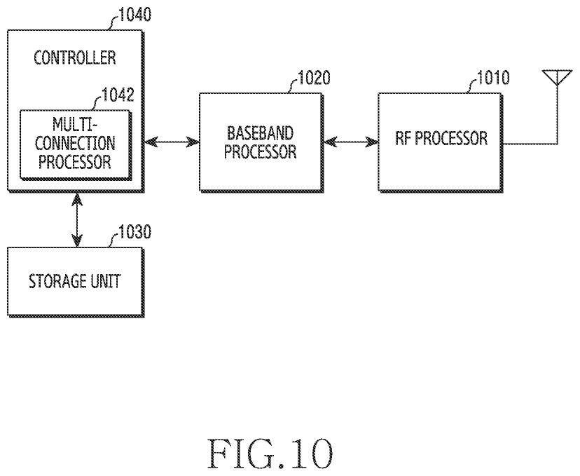

FIG. 10 is a block diagram illustrating an internal structure of a UE according to an embodiment of the disclosure.

Referring to the drawing, the UE may include a radio frequency (RF) processor 1010, a baseband processor 1020, a storage unit 1030, and a controller 1040.

The RF processor 1010 may perform functions for transmitting/receiving signals through a radio channel, such as signal band conversion and amplification. That is, the RF processor 1010 may up-convert a baseband signal provided from the baseband processor 1020 to an RF band signal, may transmit the same through an antenna, and may down-convert an RF band signal received through the antenna to a baseband signal. For example, the RF processor 1010 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 1010 may include multiple RF chains. Furthermore, the RF processor 1010 may perform beamforming. For the beamforming, the RF processor 1010 may adjust the phase and magnitude of signals transmitted/received through multiple antennas or antenna elements, respectively. In addition, the RF processor may perform MIMO, and may receive multiple layers when performing a MIMO operation.

The baseband processor 1020 may perform functions of conversion between baseband signals and bitstrings according to the system's physical layer specifications. For example, during data transmission, the baseband processor 1020 may encode and modulate a transmitted bitstring to generate complex symbols. In addition, during data reception, the baseband processor 1020 may demodulate and decode a baseband signal provided from the RF processor 1010 to restore a received bitstring. For example, when following the orthogonal frequency division multiplexing (OFDM) scheme, during data transmission, the baseband processor 1020 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1020 may split a baseband signal provided from the RF processor 1010 at the OFDM symbol level, may restore signals mapped to subcarriers through a fast Fourier transform (FFT) operation, and may restore a received bitstring through demodulation and decoding.

The baseband processor 1020 and the RF processor 1010 may transmit and receive signals as described above. Therefore, the baseband processor 1020 and the RF processor 1010 may be referred to as a transmitter, a receiver, a transceiver, or a communication unit. Furthermore, at least one of the baseband processor 1020 and the RF processor 1010 may include multiple communication modules to support multiple different radio access technologies. In addition, at least one of the baseband processor 1020 and the RF processor 1010 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

The storage unit 1030 may store basic programs, application programs, and data, such as configuration information, for operation of the main base station. Particularly, the storage unit 1030 may store information regarding a second access node configured to perform wireless communication by using a second radio access technology. In addition, the storage unit 1030 may provide the stored data at the request of the controller 1040.

The controller 1040 controls the overall operation of the UE. For example, the controller 1040 may transmit/receive signals through the baseband processor 1020 and the RF processor 1010. In addition, the controller 1040 records data in the storage unit 1030 and reads the data from the storage unit 1030. To this end, the controller 1040 may include at least one processor. For example, the controller 1040 may include a communication processor (CP) configured to perform control for communication, and an application processor (AP) configured to control upper layers such as application programs. The controller 1040 may further include a multi-connection processor 1042 to support multiple connections.

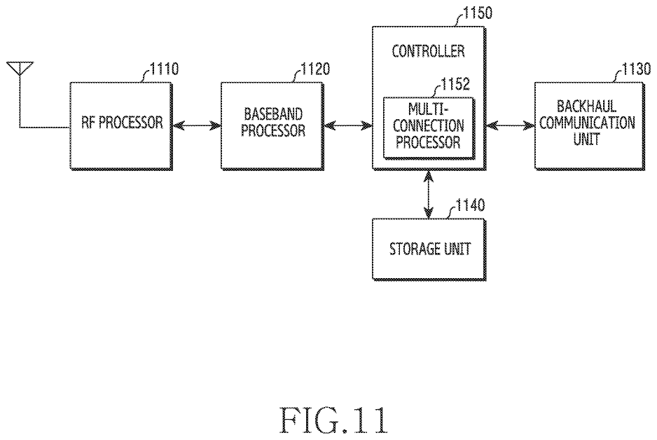

FIG. 11 is a block diagram illustrating a structure of a base station according to an embodiment of the disclosure.

As illustrated in the drawing, the base station may include an RF processor 1110, a baseband processor 1120, a backhaul communication unit 1130, a storage unit 1140, and a controller 1150.

The RF processor 1110 may perform functions for transmitting/receiving signals through a radio channel, such as signal band conversion and amplification. That is, the RF processor 1110 may up-convert a baseband signal provided from the baseband processor 1120 to an RF band signal, may transmit the same through an antenna, and may down-convert an RF band signal received through the antenna to a baseband signal. For example, the RF processor 1110 may include a transmission filter, a reception filter, an amplifier, a mixer, an oscillator, a DAC, and an ADC. Although only one antenna is illustrated in the drawing, the first access node may include multiple antennas. In addition, the RF processor 1110 may include multiple RF chains. Furthermore, the RF processor 1110 may perform beamforming. For the beamforming, the RF processor 1110 may adjust the phase and magnitude of signals transmitted/received through multiple antennas or antenna elements, respectively. The RF processor may transmit one or more layers to perform a downward MIMO operation.

The baseband processor 1120 may perform functions of conversion between baseband signals and bitstrings according to the physical layer specifications of first radio access technology. For example, during data transmission, the baseband processor 1120 may encode and modulate a transmitted bitstring to generate complex symbols. In addition, during data reception, the baseband processor 1120 may demodulate and decode a baseband signal provided from the RF processor 1110 to restore a received bitstring. For example, when following the OFDM scheme, during data transmission, the baseband processor 1120 may encode and modulate a transmitted bitstring to generate complex symbols, may map the complex symbols to subcarriers, and may configure OFDM symbols through IFFT operation and CP insertion. In addition, during data reception, the baseband processor 1120 may split a baseband signal provided from the RF processor 1110 at the OFDM symbol level, may restore signals mapped to subcarriers through FFT operation, and may restore a received bitstring through demodulation and decoding. The baseband processor 1120 and the RF processor 1110 transmit and receive signals as described above. Therefore, the baseband processor 1120 and the RF processor 1110 may be referred to as a transmitter, a receiver, a transceiver, or a communication unit.

The backhaul communication unit 1130 may provide an interface for communicating with other nodes in the network. That is, the backhaul communication unit 1130 converts bitstrings transmitted from the main base station to other nodes, for example, an auxiliary base station, a core network, etc., into physical signals, and converts physical signals received from the other nodes into bitstrings.

The storage unit 1140 may store basic programs, application programs, and data, such as configuration information, for operation of the main base station. Particularly, the storage unit 1140 may store information regarding a bearer allocated to a connected UE, a measurement result reported from the connected UE, and the like. In addition, the storage unit 1140 may store information serving as a reference to determine whether to provide multi-connection to a UE or to suspend the same. In addition, the storage unit 1140 may provide the stored data at the request of the controller 1150.

The controller 1150 controls the overall operation of the main base station. For example, the controller 1150 transmits/receives signals through the baseband processor 1120 and the RF processor 1110 or through the backhaul communication unit 1130. In addition, the controller 1150 records data in the storage unit 1140 and reads the data from the storage unit 1140. To this end, the controller 1150 may include at least one processor. The controller 1150 may further include a multi-connection processor 1152 to support multiple connections.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Furthermore, the methods of the disclosure described above in FIGS. 1 to 11 may include methods in which one or more of the drawings are combined according to various implementations. For example, the embodiments described in FIG. 1 to FIG. 11 may be combined to be connected (performed) as one flow. In addition, all or a part of an embodiment may be performed in combination with all or a part of one or more other embodiments. The disclosure may include methods in which one or more of the drawings are combined according to various implementations.

1. A method performed by a user equipment (UE) in a wireless communication system, the method comprising:
receiving, from a base station, a radio resource control (RRC) release message for configuring an RRC inactive state, wherein the RRC release message includes dedicated random access channel (RACH) configuration information for a contention-free random access;
determining to update a timing advance (TA) for a positioning sounding reference signal (SRS) in the RRC inactive state; and
transmitting, to the base station, a contention-free random access preamble for (TA) update, based on the dedicated RACH configuration information.

2. The method of claim 1, wherein the determining comprises at least one of:
identifying that a timer associated with the positioning SRS has expired;
identifying that a reference signal received power (RSRP) of a pathloss reference signal changes more than a configured threshold; or
identifying that the UE selects a cell different from a cell on which the RRC release message is received.

3. The method of claim 1, further comprising:
receiving, from the base station, a random access response for the contention-free random access preamble,
wherein the random access response comprises a TA command indicating a TA value.

4. The method of claim 1, further comprising:
receiving, from the base station, a physical downlink shared channel (PDSCH) scheduled by downlink control information (DCI) for the contention-free random access preamble,
wherein the PDSCH comprises an absolute TA command medium access control (MAC) control element (CE) indicating a TA value.

5. A method performed by a base station in a wireless communication system, the method comprising:
transmitting, to a user equipment (UE), a radio resource control (RRC) release message for configuring an RRC inactive state, wherein the RRC release message includes dedicated random access channel (RACH) configuration information for a contention-free random access; and
receiving, from the UE, a contention-free random access preamble for updating timing advance (TA) for a positioning sounding reference signal (SRS) in the RRC inactive state, based on the dedicated RACH configuration information.

6. The method of claim 5,
wherein the contention-free random access preamble is received based on at least one of:
identification on a timer associated with the positioning SRS having expired;
identification on a reference signal received power (RSRP) of a pathloss reference signal changing more than a configured threshold; or
identification on a selection of a cell different from a cell on which the RRC release message is transmitted,
wherein the method further comprises:
transmitting, to the UE, a random access response for the contention-free random access preamble, and
wherein the random access response comprises a TA command for indicating a TA value.

7. The method of claim 5, further comprising:
transmitting, to the UE, a physical downlink shared channel (PDSCH) scheduled by downlink control information (DCI) for the contention-free random access preamble,
wherein the PDSCH comprises an absolute TA command medium access control (MAC) control element (CE) indicating a TA value.

8. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, a radio resource control (RRC) release message for configuring an RRC inactive state, wherein the RRC release message includes dedicated random access channel (RACH) configuration information for a contention-free random access,
determine to update a timing advance (TA) for a positioning sounding reference signal (SRS) in the RRC inactive state, and
transmit, to the base station, a contention-free random access preamble for (TA) update, based on the dedicated RACH configuration information.

9. The UE of claim 8, wherein the instructions further cause the UE to:
identify that a timer associated with the positioning SRS has expired,
identify that a reference signal received power (RSRP) of a pathloss reference signal changes more than a configured threshold, or
identify that the UE selects a cell different from a cell on which the RRC release message is received.

10. The UE of claim 8,
wherein the instructions further cause the UE to:
receive, from the base station, a random access response for the contention-free random access preamble, and
wherein the random access response comprises a TA command indicating a TA value.

11. The UE of claim 8,
wherein the instructions further cause the UE to:
receive, from the base station, a physical downlink shared channel (PDSCH) scheduled by downlink control information (DCI) the contention-free random access preamble, and
wherein the PDSCH comprises an absolute TA command medium access control (MAC) control element (CE) indicating a TA value.

12. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), a radio resource control (RRC) release message for configuring an RRC inactive state, wherein the RRC release message includes dedicated random access channel (RACH) configuration information for a contention-free random access, and
receive, from the UE, a contention-free random access preamble for updating timing advance (TA) update for a positioning sounding reference signal (SRS) in the RRC inactive state, based on the dedicated RACH configuration information.

13. The base station of claim 12, wherein the contention-free random access preamble is received based on at least one of:
identification on a timer associated with the positioning SRS having expired;
identification on a reference signal received power (RSRP) of a pathloss reference signal changing more than a configured threshold; or
identification on a selection of a cell different from a cell on which the RRC release message is transmitted.

14. The base station of claim 12,
wherein the instructions further cause the UE to:
transmit, to the UE, a random access response for the contention-free random access preamble, and
wherein the random access response comprises a TA command for indicating a TA value.

15. The base station of claim 12,
wherein the instructions further cause the UE to:
a physical downlink shared channel (PDSCH) scheduled by downlink control information (DCI) for the contention-free random access preamble, and
wherein the PDSCH comprises an absolute TA command medium access control (MAC) control element (CE) indicating a TA value.
